(19) United States
(12) Patent Application Publication
(10) Pub. No.: US 2022/0319149 A1
(43) Pub. Date: Oct. 6, 2022

(54) SYSTEM AND METHOD FOR OBJECT RECOGNITION UNDER NATURAL AND/OR ARTIFICIAL LIGHT

(71) Applicant: BASF Coatings GmbH, Ludwigshafen am Rhein (DE)

(72) Inventors: Yunus Emre Kurtoglu, Southfield, MI (US); Matthew lan Childers, Southfield, MI (US)

(21) Appl. No.: 17/616,258

(22) PCT Filed: Jun. 5, 2020
(86) PCT No.: PCT/EP2020/065749

§ 371 Date: Dec. 3, 2021

Related U.S. Application Data
(60) Provisional application No. 62/858,356, filed on Jun. 7, 2019.

(30) Foreign Application Priority Data
Jun. 7, 2019 (EP) 19179181.3

(51) Int. Cl. G06V 10/75; G06V 10/60; G06V 10/58

(52) U.S. Cl. CPC G06V 10/76; G06V 10/60; G06V 10/58

(57) ABSTRACT

Described herein are a system and a method for object recognition via a computer vision application, the system including at least the following components:
at least one object to be recognized, the object having object specific reflectance and luminescence spectral patterns,
a light source which is configured to illuminate a scene including the at least one object, the light source being designed to omit at least one spectral band of a spectral range of light when illuminating the scene, the at least one omitted spectral band being in the luminescence spectral pattern of the at least one object,
at least one sensor which is configured to exclusively measure radiance data of the scene in at least one of the at least one omitted spectral band when the scene is illuminated by the light source,
a data storage unit, and
a data processing unit.

The present disclosure refers to a system and a method for object recognition under natural and/or artificial light using light filters.

### BACKGROUND

Computer vision is a field in rapid development due to abundant use of electronic devices capable of collecting information about their surroundings via sensors such as cameras, distance sensors such as LiDAR or radar, and depth camera systems based on structured light or stereo vision to name a few. These electronic devices provide raw image data to be processed by a computer processing unit and consequently develop an understanding of an environment or a scene using artificial intelligence and/or computer assistance algorithms. There are multiple ways how this understanding of the environment can be developed. In general, 2D or 3D images and/or maps are formed, and these images and/or maps are analyzed for developing an understanding of the scene and the objects in that scene. One prospect for improving computer vision is to measure the components of the chemical makeup of objects in the scene. While shape and appearance of objects in the environment acquired as 2D or 3D images can be used to develop an understanding of the environment, these techniques have some shortcomings.

One challenge in computer vision field is being able to identify as many objects as possible within each scene with high accuracy and low latency using a minimum amount of resources in sensors, computing capacity, light probe etc. The object identification process has been termed remote sensing, object identification, classification, authentication or recognition over the years. In the scope of the present disclosure, the capability of a computer vision system to identify an object in a scene is termed as “object recognition”. For example, a computer analyzing a picture and identifying/labelling a ball in that picture, sometimes with even further information such as the type of a ball (basketball, soccer ball, baseball), brand, the context, etc. fall under the term “object recognition”.

Generally, techniques utilized for recognition of an object in computer vision systems can be classified as follows:

Technique 1: Physical tags (image based): Barcodes, QR codes, serial numbers, text, patterns, holograms etc.

Technique 2: Physical tags (scan/close contact based): Viewing angle dependent pigments, upconversion pigments, metachromics, colors (red/green), luminescent materials.

Technique 3: Electronic tags (passive): RFID tags, etc. Devices attached to objects of interest without power, not necessarily visible but can operate at other frequencies (radio for example).

Technique 4: Electronic tags (active): wireless communications, light, radio, vehicle to vehicle, vehicle to anything (X), etc. Powered devices on objects of interest that emit information in various forms.

Technique 5: Feature detection (image based): Image analysis and identification, i.e. two wheels at certain distance for a car from side view; two eyes, a nose and mouth (in that order) for face recognition etc. This relies on known geometries/shapes.

Technique 6: Deep learning/CNN based (image based): Training of a computer with many of pictures of labeled images of cars, faces etc. and the computer determining the features to detect and predicting if the objects of interest are present in new areas. Repeating of the training procedure for each class of object to be identified is required.

Technique 7: Object tracking methods: Organizing items in a scene in a particular order and labeling the ordered objects at the beginning. Thereafter following the object in the scene with known color/geometry/3D coordinates. If the object leaves the scene and re-enters, the “recognition” is lost.

In the following, some shortcomings of the above-mentioned techniques are presented.

Technique 1: When an object in the image is occluded or only a small portion of the object is in the view, the barcodes, logos etc. may not be readable. Furthermore, the barcodes etc. on flexible items may be distorted, limiting visibility. All sides of an object would have to carry large barcodes to be visible from a distance otherwise the object can only be recognized in close range and with the right orientation only. This could be a problem for example when a barcode on an object on the shelf at a store is to be scanned. When operating over a whole scene, technique 1 relies on ambient lighting that may vary.

Technique 2: Upconversion pigments have limitations in viewing distances because of the low level of emitted light due to their small quantum yields. They require strong light probes. They are usually opaque and large particles limiting options for coatings. Further complicating their use is the fact that compared to fluorescence and light reflection, the upconversion response is slower. While some applications take advantage of this unique response time depending on the compound used, this is only possible when the time of flight distance for that sensor/object system is known in advance. This is rarely the case in computer vision applications. For these reasons, anti-counterfeiting sensors have covered/dark sections for reading, class 1 or 2 lasers as probes and a fixed and limited distance to the object of interest for accuracy.

Similarly viewing angle dependent pigment systems only work in close range and require viewing at multiple angles. Also, the color is not uniform for visually pleasant effects. The spectrum of incident light must be managed to get correct measurements. Within a single image/scene, an object that has angle dependent color coating will have multiple colors visible to the camera along the sample dimensions.

Color-based recognitions are difficult because the measured color depends partly on the ambient lighting conditions. Therefore, there is a need for reference samples and/or controlled lighting conditions for each scene. Different sensors will also have different capabilities to distinguish different colors, and will differ from one sensor type/maker to another, necessitating calibration files for each sensor.

Luminescence based recognition under ambient lighting is a challenging task, as the reflective and luminescent components of the object are added together. Typically luminescence based recognition will instead utilize a dark measurement condition and a priori knowledge of the excitation region of the luminescent material so the correct light probe/source can be used.

Technique 3: Electronic tags such as RFID tags require the attachment of a circuit, power collector, and antenna to the item/object of interest, adding cost and complication to the design. RFID tags provide present or not type information but not precise location information unless many sensors over the scene are used.

Technique 4: These active methods require the object of interest to be connected to a power source, which is cost-prohibitive for simple items like a soccer ball, a shirt, or a box of pasta and are therefore not practical.

Technique 5: The prediction accuracy depends largely on the quality of the image and the position of the camera within the scene, as occlusions, different viewing angles, and the like can easily change the results. Logo type images can be present in multiple places within the scene (i.e., a logo can be on a ball, a T-shirt, a hat, or a coffee mug) and the object recognition is by inference. The visual parameters of the object must be converted to mathematical parameters at great effort. Flexible objects that can change their shape are problematic as each possible shape must be included in the database. There is always inherent ambiguity as similarly shaped objects may be misidentified as the object of interest.

Technique 6: The quality of the training data set determines the success of the method. For each object to be recognized/classified many training images are needed. The same occlusion and flexible object shape limitations as for Technique 5 apply. There is a need to train each class of material with thousands or more of images.

Technique 7: This technique works when the scene is pre-organized, but this is rarely practical. If the object of interest leaves the scene or is completely occluded the object could not be recognized unless combined with other techniques above.

Apart from the above-mentioned shortcomings of the already existing techniques, there are some other challenges worth mentioning. The ability to see a long distance, the ability to see small objects or the ability to see objects with enough detail all require high resolution imaging systems, i.e. high-resolution camera, LiDAR, radar etc. The high-resolution needs increase the associated sensor costs and increase the amount of data to be processed.

For applications that require instant responses like autonomous driving or security, the latency is another important aspect. The amount of data that needs to be processed determines if edge or cloud computing is appropriate for the application, the latter being only possible if data loads are small. When edge computing is used with heavy processing, the devices operating the systems get bulkier and limit ease of use and therefore implementation.

Thus, a need exists for systems and methods that are suitable for improving object recognition capabilities for computer vision applications.

### SUMMARY OF THE INVENTION

The present disclosure provides a system and a method with the features of the independent claims. Embodiments are subject of the dependent claims and the description and drawings.

According to claim 1, a system for object recognition via a computer vision application is provided, the system comprising at least the following components:
at least one object to be recognized, the object having an object specific reflectance spectral pattern and an object specific luminescence spectral pattern,
a natural and/or artificial light source which is configured to illuminate a scene including the at least one object, the light source being designed to omit at least one spectral band of a spectral range of light when illuminating the scene, the at least one omitted spectral band being in the luminescence spectral pattern of the at least one object,
a sensor which is configured to measure radiance data of the scene including the at least one object when the scene is illuminated by the light source, and to read at the at least one omitted spectral band,
a data storage unit which comprises luminescence spectral patterns together with appropriately assigned respective objects,
a data processing unit which is configured to calculate/extract/derive the object specific luminescence spectral pattern of the at least one object to be recognized from the measured radiance data of the scene within the at least one omitted spectral band and to match the calculated/extracted/derived object specific luminescence spectral pattern with the luminescence spectral patterns stored in the data storage unit, and to identify a best matching luminescence spectral pattern and, thus, its assigned object.

According to one possible embodiment of the system, the light source is a LED light source which is configured to intentionally and intrinsically leave out (omit) the at least one individual spectral band of the spectral range of light when illuminating the scene. The LED light source can be composed of a plurality of narrow band LEDs, each LED being configured to emit light in a narrow spectral band, the spectral bands of the LEDs being spaced apart from each other with omitted individual spectral bands in between them.

In a further aspect of the proposed system, the light source is equipped with at least one light filter, the at least one light filter being designed to block the at least one individual spectral band of the spectral range of light from entering the scene.

The term “individual spectral band”, in the following also simply called “spectral band”, indicates a spectral band spanning only one or a comparatively small number of successive wavelengths of light within the spectral range of light which span a comparatively higher number of successive wavelengths of light.

Within the scope of the present disclosure ambient light can be either natural light or artificial/room light, but normally not both. In some cases, it can be both and both can be filtered at the same spectral bands. One of such cases is given when sun is shining through a window of a room and the room is further illuminated by a light bulb. Natural light can be, for example, sun light, moon light, light of stars, etc. Artificial light may be light from bulbs, etc.

Within the scope of the present disclosure, the terms “fluorescent” and “luminescent” are used synonymously. The same applies to the terms “fluorescence” and “luminescence”.

According to one aspect of the present disclosure, the at least one light filter is designed as a dynamic light filter which is configured to block at least one spectral band of light from entering the scene at a time and to change the at least one spectral band which is to be blocked dynamically, thus blocking at least one portion of the spectral range of light over time.

It is possible to pre-give a plurality of individual spectral bands, each spectral band being in the luminescence spectral pattern of the at least one object, and to let the system randomly choose which spectral band(s) to be omitted/blocked when illuminating the scene. Such selection is performed by choosing and/or activating at least one suitable light source among a plurality of light sources, each light source of the plurality of light sources being configured to omit a spectral band of the plurality of spectral bands, and/or to control a light source which is configured to omit/block all the spectral bands of the plurality of spectral bands selectively, so that the light source omits one or more of the spectral bands randomly (activating/deactivating a filter with which the light source is equipped and/or to activating/choosing one or more single LEDs of a LED light source).

Further, the dynamic light filter is configured to continuously operate over the light spectral range of interest and to provide blocking of at least one band of interest on demand, particularly at wavelengths covered by the luminescence spectral pattern of the at least one object.

According to a further embodiment of the proposed system, the system comprises a plurality of dynamic light filters on the same natural and/or artificial light source and/or on multiple natural or artificial light sources illuminating the scene, wherein the filters are configured to be synchronized with each other to block the same spectral band or bands simultaneously.

In still another embodiment of the claimed system, the at least one light filter is designed as a notch filter which is configured to block light entering the scene from a window as in natural lighting or an artificial lighting element at at least one distinct spectral band continuously.

The notch filter may be designed to block a plurality of distinct spectral bands within the spectral range of light.

By using narrow or wide band notch filters it is possible to block certain portions of light spectrum from entering a scene/an environment. Such notch filters can be designed to have broad or narrow blocking bands with high or low blocking performance. Such notch filters can be designed to include one or several blocking bands (multi-notch filters) via layering of multiple films or other techniques. Alternatively, the same objective can be achieved by using light filtering elements that block portions of the spectral band at a time but have the capability to change the blocking band wavelength dynamically (dynamic light filter). Such dynamic light filters can be operated to continuously scan the spectral range and provide blocking at a wavelength band(s) of interest on demand, like a notch filter.

According to another embodiment of the proposed system, the at least one sensor is a camera which is configured to image the scene and to record radiance data over the scene at different wavelength ranges of the spectral range of light at time intervals of interest, particularly at time intervals when individual spectral band(s) are omitted, e. g. when filtering is taking place.

The sensor may be a hyperspectral camera or a multispectral camera. The sensor is generally an optical sensor with photon counting capabilities. More specifically, it may be a monochrome camera, or an RGB camera, or a multispectral camera, or a hyperspectral camera. The sensor may be a combination of any of the above, or the combination of any of the above with a tuneable or selectable filter set, such as, for example, a monochrome sensor with specific filters. The sensor may measure a single pixel of the scene, or measure many pixels at once. The optical sensor may be configured to count photons in a specific range of spectrum, particularly in more than three bands. It may be a camera with multiple pixels for a large field of view, particularly simultaneously reading all bands or different bands at different times.

A multispectral camera captures image data within specific wavelength ranges across the electromagnetic spectrum. The wavelengths may be separated by filters or by the use of instruments that are sensitive to particular wavelengths, including light from frequencies beyond the visible light range, i.e. infrared and ultra-violet. Spectral imaging can allow extraction of additional information the human eye fails to capture with its receptors for red, green and blue. A multispectral camera measures light in a small number (typically 3 to 15) of spectral bands. A hyperspectral camera is a special case of spectral camera where often hundreds of contiguous spectral bands are available.

In a further aspect, the data processing unit is configured to calculate the object specific luminescence spectral pattern of the at least one object to be recognized based on the radiance data of the scene within the spectral bands that are omitted/blocked/filtered, e. g. based on the spectral distribution of the at least one light filter, and to match the calculated object specific luminescence spectral pattern with the luminescence spectral patterns stored in the data storage unit, and to identify a best matching luminescence spectral pattern and, thus, its assigned object.

The present disclosure further refers to a method for object recognition via a computer vision application, the method comprising at least the following steps:
providing an object to be recognized, the object having object specific reflectance and luminescence spectral patterns,
illuminating a scene including the object using a natural and/or artificial light source, the light source being designed to omit at least one individual spectral band of a spectral range of light from when illuminating the scene, the at least one spectral band being adapted to the luminescence spectral pattern of the at least one object and covering at least one wavelength of the luminescence spectral pattern, i.e. the at least one filtered spectral band being in the luminescent spectral range of the object,
measuring, by means of a sensor, radiance data of the scene including the object when the scene is illuminated by the light source, and reading at the at least one omitted spectral band,
providing a data storage unit which comprises luminescence spectral patterns together with appropriately assigned respective objects,
extracting, by means of a data processing unit, the object specific luminescence spectral pattern of the object to be recognized out of the measured radiance data of the scene,
matching the extracted object specific luminescence spectral pattern with the luminescence spectral patterns stored in the data storage unit, and
identifying a best matching luminescence spectral pattern and, thus, its assigned object.

According to one embodiment of the proposed method, the light source is equipped with at least one light filter which is designed to block the at least one individual spectral band. Alternatively, the light source is chosen as a LED light source with one or more LEDs, each LED being configured to emit light in a narrow spectral band, the spectral bands of the LEDs being spaced apart from each other with omitted individual spectral bands in between them.

In a further aspect, the method further comprises choosing the at least one light filter as a dynamic filter and scanning the light spectral range of interest and providing blocking at a wavelength/spectral band of interest on demand, particularly at wavelengths covered by the luminescence spectral pattern of the at least one object.

According to still a further aspect, the proposed method comprises choosing the at least one light filter as a notch filter which is configured to block at least one distinct spectral band permanently, particularly to block a plurality of distinct spectral bands within the spectral range of light. The notch filter may be configured to block light entering the scene from a window as in natural lighting or an artificial lighting element at at least one distinct spectral band continuously.

According to still another embodiment of the proposed method, extracting the object specific luminescence spectral pattern comprises calculating the object specific luminescence spectral pattern of the at least one object to be recognized based on the radiance data of the scene within the at least one spectral band that is omitted, e. g. based on the spectral distribution of the at least one light filter and the measured radiance data of the scene and matching the calculated object specific luminescence spectral pattern with the luminescence spectral patterns stored in the data storage unit, and identifying a best matching luminescence spectral pattern and, thus, its assigned object.

Generally, at least the light source, the sensor, the data processing unit and the data storage unit (the database) are networked among each other via respective communicative connections. Thus, each of the communicative connections between the different components of the monitoring device may be a direct connection or an indirect connection, respectively. Each communicative connection may be a wired or a wireless connection. Each suitable communication technology may be used. The data processing unit, the sensor, the data storage unit, the light source, each may include one or more communications interfaces for communicating with each other. Such communication may be executed using a wired data transmission protocol, such as fiber distributed data interface (FDDI), digital subscriber line (DSL), Ethernet, asynchronous transfer mode (ATM), or any other wired transmission protocol. Alternatively, the communication may be wirelessly via wireless communication networks using any of a variety of protocols, such as General Packet Radio Service (GPRS), Universal Mobile Telecommunications System (UMTS), Code Division Multiple Access (CDMA), Long Term Evolution (LTE), wireless Universal Serial Bus (USB), and/or any other wireless protocol. The respective communication may be a combination of a wireless and a wired communication.

The data processing unit may include or may be in communicative connection with one or more input units, such as a touch screen, an audio input, a movement input, a mouse, a keypad input and/or the like. Further the data processing unit may include or may be in communication, i. e. in communicative connection with one or more output units, such as an audio output, a video output, screen/display output, and/or the like.

Embodiments of the invention may be used with or incorporated in a computer system that may be a standalone unit or include one or more remote terminals or devices in communication with a central computer, located, for example, in a cloud, via a network such as, for example, the Internet or an intranet. As such, the data processing unit described herein and related components may be a portion of a local computer system or a remote computer or an online system or a combination thereof. The database, i.e. the data storage unit and software described herein may be stored in computer internal memory or in a non-transistory computer readable medium. Within the scope of the present disclosure the database may be part of the data storage unit or may represent the data storage unit itself. The terms “database” and “data storage unit” are used synonymously.

The present disclosure further refers to a computer program product having instructions that are executable by a computer, the computer program product comprising instructions to:
provide an object to be recognized, the object having object specific reflectance and luminescence spectral patterns,
illuminate a scene including the object using a natural and/or artificial light source, the light source being designed to omit at least one individual spectral band of a spectral range of light when illuminating the scene, the at least one spectral band being adapted to the luminescence spectral pattern of the at least one object and covering at least one wavelength of the luminescence spectral pattern, i.e. the at least one omitted spectral band being in the luminescent spectral range of the object,
measure radiance data of the scene including the object when the scene is illuminated by the light source, and to read at the at least one filtered spectral band,
provide a data storage unit which comprises luminescence spectral patterns together with appropriately assigned respective objects,
extract the object specific luminescence spectral pattern of the object to be recognized out of the measured radiance data of the scene, and
match the extracted object specific luminescence spectral pattern with the luminescence spectral patterns stored in the data storage unit, and
identify a best matching luminescence spectral pattern and, thus, its assigned object.

The light source may be equipped with at least one light filter that is designed to block the at least one individual spectral band from entring the scene.

In one aspect, the computer program product further having instructions to calculate the object specific luminescence spectral pattern of the at least one object to be recognized based on the radiance data of the scene within the at least one spectral band and to match the calculated object specific luminescence spectral pattern with the luminescence spectral patterns stored in the data storage unit, and to identify a best matching luminescence spectral pattern and, thus, its assigned object.

The present disclosure describes a system and a method to detect a fluorescence emission spectrum of an object/material within a scene under unchanging (steady state) ambient lighting conditions. The system may comprise notch filters applied to sources of light in an indoor space (light bulbs of various types and/or windows, etc.), or dark or low ambient light conditions outdoor using the same filtered light sources, a sensor/camera capable of scanning the scene and recording responses over the scene at different wavelength ranges, and a data processing unit configured to calculate the fluorescence emission spectrum based on the spectral distribution of the notch filters, i.e. based on the measured radiance data from the sensor/camera which has been measured within the omitted spectral bands of the light source. Alternatively, the system can be built using dynamic light filters placed on sources of light for a scene that can block portions of the light spectrum at a time and scan the spectral range over time. If multiple dynamic light filters are used for the system, each filter can be synchronized to block the same spectral band(s) simultaneously for accommodating luminescence readings of the target object at that blocked spectral band(s). It is also possible that multiple different spectral bands are blocked simultaneously. Alternatively, the light source is chosen as a LED light source with one or more LEDs, each LED being configured to emit light in a narrow spectral band, the spectral bands of the LEDs being spaced apart from each other with omitted individual spectral bands in between them. The system further includes a data storage unit with a database of luminescent materials/objects and a data/computer processing unit that computes the spectral match of such luminescent objects using various algorithms. The proposed system and method enable color space-based object recognition using luminescent objects/materials for indoor environments as well as low light outdoor environments with or without sunlight entering the scene and without the need for high frequency variable illumination source.

The invention is further defined in the following examples. It should be understood that these examples, by indicating preferred embodiments of the invention, are given by way of illustration only. From the above discussion and the examples, one skilled in the art can ascertain the essential characteristics of this invention and without departing from the spirit and scope thereof, can make various changes and modifications of the invention to adapt it to various uses and conditions.

### BRIEF DESCRIPTION OF THE DRAWINGS

FIG. 1a shows a schematic diagram of an unfiltered illuminant spectrum and a notch filter transmission spectrum;

FIG. 1b shows a schematic diagram of a resulting illuminant spectrum after filtration, i.e. a superimposing of the unfiltered illuminant spectrum and the notch filter transmission spectrum of FIG. 1a.

FIG. 2 shows a schematic diagram of a notch filter transmission spectrum and one sensor band being located within each notch filter blocking band,

FIG. 3 shows a schematic diagram of a notch filter transmission spectrum and multiple sensor bands being located within each notch filter blocking band

FIG. 4 shows schematically one embodiment of the proposed system.

### DETAILED DESCRIPTION OF THE DRAWINGS

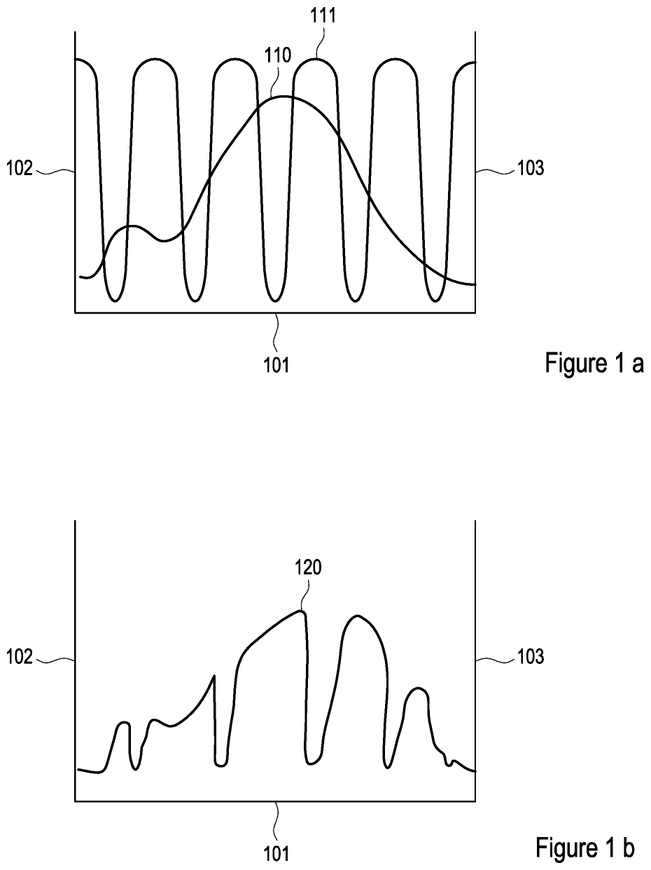

FIG. 1 a shows a diagram with a horizontal axis 101 and two vertical axes 102 and 103. The diagram is shown for an embodiment of the proposed system for object recognition via a computer vision application. The system comprises at least a natural and/or artificial light source which comprises at least one illuminant to illuminate a scene including at least one object to be recognized.

The at least one object to be recognized has object-specific reflectance and luminescence spectral patterns. The light source is equipped with at least one notch filter which is designed to block at least one predefined spectral band within a spectral range of light from entering the scene wherein the at least one filtered spectral band lies within the luminescence spectral pattern, i.e. the luminescent spectral range of the at least one object. The wavelength of the spectral range of light is plotted along the horizontal axis 101. The transmission of the notch filter is plotted along the vertical axis 103, wherein the transmission is given in percent. A radiance intensity of the light source, i.e. of the illuminant comprised by the light source, is plotted along the vertical axis 102. The curve 110 indicates the developing of radiance intensity values of the light source as a function of the wavelength, and the curve 111 indicates the transmission of the notch filter as a function of the wavelength. Thus, in the diagram of FIG. 1a an unfiltered illuminant spectrum and a notch filter transmission spectrum are plotted as respective functions of the wavelength independently from each other.

FIG. 1b shows a diagram wherein the curves 110 and 111 from FIG. 1a are superimposed with each other forming curve 120, thus, indicating which spectral bands are filtered/blocked from entering the scene. As already indicated above, the filtered spectral bands are chosen as being correlated with the luminescence spectral pattern of the object to be recognized so that radiance data resulting from those spectral bands (blocked from illumination) and measured by the sensor have to be unambiguously assigned to the luminescence spectral pattern of the at least one object and, therefore, give clear indication of the at least one object. The notch filter shown here blocks five spectral bands along the wavelength range which is plotted along the horizontal axis 101. As no light within the blocked spectral bands can enter the scene, no light within those spectral bands can be reflected and, therefore, all light which can be sensed/measured by the sensor within those spectral bands has to be resulting from the luminescence spectral pattern of the at least one object.

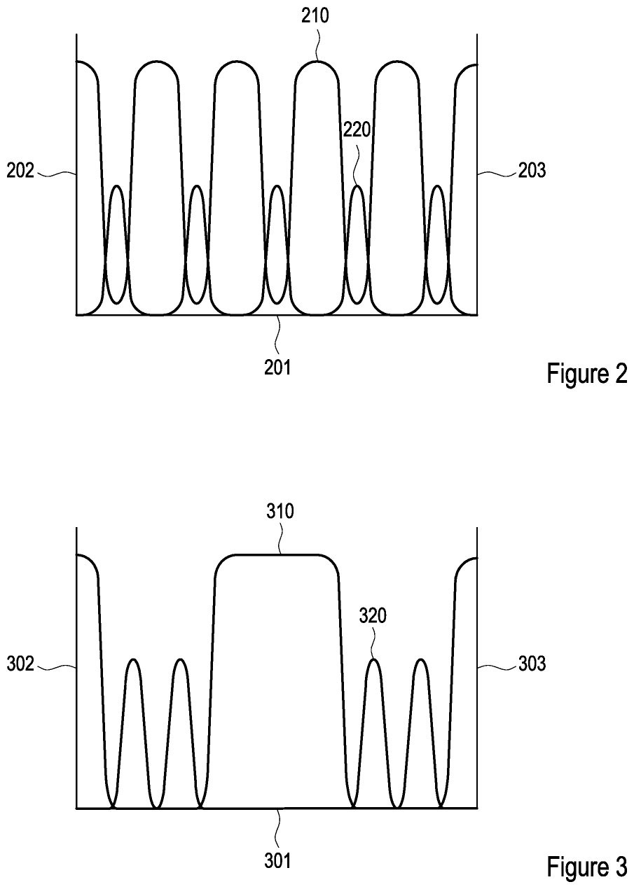

FIG. 2 shows a schematic diagram for a system which comprises the light source, the notch filter and a respective sensor which is configured to measure radiance data of the scene including the at least one object when the scene is illuminated by the light source. The diagram has a horizontal axis 201 and two vertical axes 202 and 203. The wavelength of light entering the scene and of light being radiated from the scene is plotted along the horizontal axis 201. A sensor sensitivity is plotted along the vertical axis 202. A transmission capability of the notch filter is plotted along the axis 203. The transmission is given in percent. The notch filter is chosen as a multiband notch filter, i.e. the notch filter is configured to block multiple spectral bands of the spectral range of light from entering the scene, the spectral range of light being defined by the beginning and the end of the horizontal axis 201. In the case shown here, the notch filter blocks, as indicated by curve 210, five spectral bands along the spectral range of light defined by the horizontal axis 201. The sensor is configured, as indicated by curve 220, to particularly measure radiance data whithin exactly the five spectral bands of the spectral range of light which are blocked by the notch filter from entering the scene. Therefore, the sensor is explicitly configured to sense only light which is emitted from the scene as luminescent response to the entering light. The reflected response of the scene is masked as the sensor is not configured to measure radiance data within the spectral bands which are not blocked by the notch filter. Therefore, it is possible to focus the measurement made by the sensor on the luminescence response of the scene. If the spectral bands of the notch filter which are blocked are adapted to the luminescence spectral pattern of the at least one object to be recognized, the sensor can clearly measure the radiance data resulting from the luminescence spectral pattern of the object and enables to clearly identify the object due to its measured luminescence spectral pattern.

FIG. 3 shows a further example of diagram. The wavelength of light entering a scene or emitting from the scene is plotted along the horizontal axis 301. A sensor sensitivity is again plotted along vertical axis 302. A transmission capacity of a notch filter is again plotted again a vertical axis 303. Within the wavelength range defined by the horizontal axis 301, the notch filter has two spectral bands which are blocked and three spectral bands which are not blocked as indicated by curve 310. In the example shown here, the sensor is configured to measure two spectral bands within each blocked spectral band of the notch filter as indicated by curve 320. That means that multiple sensor bands are located within each notch filter band, i. e. within each spectral band which is blocked by the notch filter. In the case that the sensor with its sensor bands is chosen to be adapted/to correlate with the luminescence spectral pattern of the object to be recognized and the notch filter with its blocking spectral bands is also adapted to the luminescence spectral pattern of the object, the object can be unambiguously identified due to its luminescence spectral pattern which can be measured in detail by the respective sensor.

Methods for measuring a fluorescence emission spectrum from an object containing fluorescence emission and reflectance are already known. Most of these methods rely on measuring a radiance spectrum of the object under two or more lighting conditions which have to be known and using various calculations to separate out the reflection and emission contribution to the total radiance of the object. However, using multiple lighting conditions is not ideal for non-laboratory environments, as the additional lighting conditions increase the cost of the light sources and add complexity challenges in syncing the light source to the sensors used. There is one paper describing a separation fluorescence emission and reflectance under a single lighting condition (Zheng, Fu, Lam, Sato, and Sato, ICCV2015 3523-3531). Within this paper, a “spiky” illumination source, i.e. a high-intensity discharge bulb used principally for automotive headlights, is used. Thus, there is still a need for generalizable methods and systems for separating reflectance and fluorescence emission under single light source conditions.

The proposed system and method enable to intentionally create dark regions in an illumination spectrum and to then measure a radiance within those dark regions. Objects with no fluorescence will not register a radiance within the dark regions, as there is no illumination for them to reflect at these wavelengths. Objects with fluorescence emission that overlaps the dark regions will have a radiance due to the conversion of higher energy light. These dark regions can be created by the application of notch filters, which are filters that transmit most of the light over their effective range with an exception of a relatively small portion of the spectrum, which should be as close to zero transmission as possible. Notch filters, including filters with multiple “notches” in a single filter, are commercially available. It is proposed to apply notch filters to illumination sources such as light bulbs and outside windows to create an environment/a scene in which an object is to be recognized. A sensor, particularly a camera with spectral sensitivity within the dark regions of the illuminant spectrum is also required. To get a fluorescence spectral shape, either multiple dark regions (FIG. 2) or a larger dark region with multiple sensor bands within that region (FIG. 3) will be required. Additionally, dynamic notch filters, where the “notch” portion of the spectrum is changeable over time, may be available. With dynamic notch filters an entire spectrum can be scanned over time, allowing for better identification of a fluorescence spectrum of a respective object to be recognized.

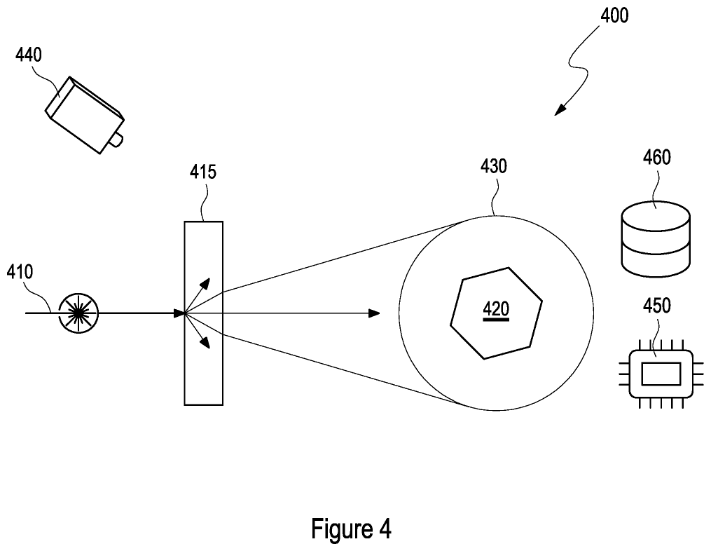

FIG. 4 shows an embodiment of the proposed system. The system 400 comprises an object to be recognized 420, a light source 410, a sensor 440, a data storage unit 460 and a data processing unit 450. The object 420 has an object specific reflectance spectral pattern and an object specific luminescence spectral pattern. The light source 410 is configured to emit UV, visible or infrared light in a spectral range of light. Generally, it is possible that the light source 410 is configured to emit light spanning the whole spectral range of light. In that case, the light source is coupled/equipped with a light filter 415 which is designed to block at least one individual spectral band of the spectral range of light from entering a scene 430 including the object 420 when the light source 410 emits light towards the scene 430. The light source 410 may also be the sun and the filter 415 can be a window fitted with filters and optionally with a sensor, such as a camera 440 (see FIG. 4). The at least one individual spectral band which is blocked lies within the luminescence spectral pattern of the object 420. Alternatively, the light source 410 is designed to leave out intrinsically at least one individual spectral band, i.e. the light source 410 does not emit light within said individual spectral band when illuminiating the scene 430 including the object 420. According to one possible embodiment of the system, the light source is a LED light source which is configured to intentionally and intrinsically leave out (omit) the at least one spectral band of the spectral range of light when illuminating the scene. The LED light source can be composed of a plurality of narrow band LEDs, each LED being configured to emit light in a narrow spectral band, the spectral bands of the LEDs being spaced apart from each other with omitted spectral bands in between them.

A combination of such light source with a filter is also possible. The system 400 shown in FIG. 4 further comprises a sensor 440 which is configured to sense/record radiance data/responses over the scene 430 at the at least one spectral band which has been left out when illuminating the scene 430. That means that only a fluorescent response of the scene 430 including the object 420 to be recognized is recorded, i.e. the fluorescent response of the object 420 provided that no further item with a similar fluorescence spectral pattern is present within the scene. The system 400 further comprises a data processing unit 450 and a data storage unit 460. The data storage unit comprises a database of fluorescence spectral patterns of a plurality of different objects. The data processing unit is in communicative connection with the data storage unit and also with the sensor 440. Therefore, the data processing unit 450 can calculate the luminescence emission spectrum of the object 420 to be recognized and search the database 460 of the data storage unit for a match with the calculated luminescence emission spectrum. Thus, the object 420 to be recognized can be identified if a match within the database 460 can be found.

### LIST OF REFERENCE SIGNS

101 horizotal axis

102 vertical axis

103 vertical axis

110 curve

111 curve

120 curve

201 horizontal axis

202 vertical axis

203 vertical axis

210 curve

220 curve

301 horizontal axis

302 vertical axis

303 vertical axis

310 curve

320 curve

400 system

410 light source

415 filter

420 object to be recognized

430 scene

440 sensor

450 data processing unit

460 data storage unit

1. A system for object recognition via a computer vision application, the system comprising at least the following components:
at least one object to be recognized, the object having object specific reflectance and luminescence spectral patterns,
a light source which is configured to illuminate a scene including the at least one object, the light source being designed to omit at least one spectral band of a spectral range of light when illuminating the scene, the at least one omitted spectral band being in the luminescence spectral pattern of the at least one object,
at least one sensor which is configured to exclusively measure radiance data of the scene in at least one of the at least one omitted spectral band when the scene is illuminated by the light source,
a data storage unit which comprises luminescence spectral patterns together with appropriately assigned respective objects, and
a data processing unit which is configured to extract the object specific luminescence spectral pattern of the at least one object to be recognized out of the measured radiance data of the scene and to match the extracted object specific luminescence spectral pattern with the luminescence spectral patterns stored in the data storage unit, and to identify a best matching luminescence spectral pattern and, thus, its assigned object.

2. The system according to claim 1, wherein the light source is a LED light source which is configured to intentionally and intrinsically leave out the at least one spectral band of the spectral range of light when illuminating the scene.

3. The system according to claim 2, wherein the LED light source is configured to omit a plurality of spectral bands and composed of a plurality of narrow band LEDs, each LED being configured to emit light in a narrow spectral band, the spectral bands of the LEDs being spaced apart from each other with the omitted spectral bands in between them.

4. The system according to claim 1, wherein the light source is equipped with at least one light filter, the at least one light filter being designed to block the at least one spectral band of the spectral range of light from entering the scene.

5. The system according to claim 4, wherein the at least one light filter is designed as a dynamic light filter which is configured to block at least one spectral band of light from entering the scene at a time and to change the at least one spectral band which is to be blocked dynamically, thus blocking at least one portion of the spectral range of light over time.

6. The system according to claim 5, wherein the dynamic light filter is configured to continuously operate over the light spectral range of interest and to provide blocking of at least one of the at least one spectral band of interest on demand.

7. The system according to claim 4 which comprises a plurality of dynamic light filters on the same natural and/or artificial light source and/or on multiple natural and/or artificial light sources illuminating the scene, wherein the filters are configured to be synchronized with each other to block at least a portion of the same one of the at least one spectral band simultaneously.

8. The system according to claim 4, wherein the at least one light filter is designed as a notch filter which is configured to block light entering the scene from a window as in natural lighting or an artificial lighting element at the at least one distinct spectral band continuously.

9. The system according to claim 8, wherein the notch filter is designed to block a plurality of distinct spectral bands within the spectral range of light.

10. The system according to claim 1, wherein the at least one sensor is a camera which is configured to image the scene and to record radiance data over the scene exclusively at different spectral bands of the at least one spectral band of the spectral range of light at time intervals when the scene is illuminated by the light source.

11. The system according to claim 10, wherein the sensor is a hyperspectral camera or a multispectral camera.

12. The system according to claim 1, wherein the data processing unit is configured to calculate the object specific luminescence spectral pattern of the at least one object to be recognized based on the spectral distribution of the measured radiance data of the scene and to match the calculated object specific luminescence spectral pattern with the luminescence spectral patterns stored in the data storage unit, and to identify a best matching luminescence spectral pattern and, thus, its assigned object.

13. A method for object recognition via a computer vision application, the method comprising at least the following steps:
providing an object to be recognized, the object having object specific reflectance and luminescence spectral patterns,
illuminating a scene including the object using a light source, the light source being designed to omit at least one spectral band of a spectral range of light when illuminating the scene, the at least one omitted spectral band being in the luminescence spectral pattern of the at least one object,
measuring, by means of at least one sensor, radiance data of the scene exclusively at the at least one omitted spectral band when the scene is illuminated by the light source,
providing a data storage unit which comprises luminescence spectral patterns together with appropriately assigned respective objects,
extracting, by means of a data processing unit, the object specific luminescence spectral pattern of the object to be recognized out of the measured radiance data of the scene,
matching the extracted object specific luminescence spectral pattern with the luminescence spectral patterns stored in the data storage unit, and
identifying a best matching luminescence spectral pattern and, thus, its assigned object.

14. The method according to claim 13, wherein the light source is chosen as a LED light source which is configured to intentionally and intrinsically leave out the at least one spectral band of the spectral range of light when illuminating the scene.

15. The method according to claim 13, wherein the light is source is equipped with at least one light filter, the at least one light filter being designed to block the at least one spectral band of the spectral range of light from entering the scene.

16. The method according to claim 15, further comprising choosing the at least one light filter as a dynamic filter and operating over the light spectral range of interest and providing blocking of at least one of the at least one spectral band of interest on demand.

17. The method according to claim 15, further comprising choosing the at least one light filter as a notch filter which is configured to block light from entering the scene from a window as in natural lighting or an artificial lighting element at the at least one distinct spectral band continuously.

18. The method according to claim 13, further comprising calculating the object specific luminescence spectral pattern of the at least one object to be recognized based on the spectral distribution of the at least one omitted spectral band and the measured radiance data of the scene and matching the calculated object specific luminescence spectral pattern with the luminescence spectral patterns stored in the data storage unit, and identifying a best matching luminescence spectral pattern and, thus, its assigned obj ect.

19. A non-transitory computer-readable medium storing instructions that, when executed by one or more processors, cause a machine to:
provide an object to be recognized, the object having object specific reflectance and luminescence spectral patterns,
illuminate a scene including the object using a light source, the light source being designed to omit at least one spectral band of a spectral range of light when illuminating the scene, the at least one omitted spectral band being in the luminescence spectral pattern of the at least one object,
measure radiance data of the scene exclusively at the at least one omitted spectral band when the scene is illuminated by the light source,
provide a data storage unit which comprises luminescence spectral patterns together with appropriately assigned respective objects,
extract the object specific luminescence spectral pattern of the object to be recognized out of the measured radiance data of the scene,
match the extracted object specific luminescence spectral pattern with the luminescence spectral patterns stored in the data storage unit, and
identify a best matching luminescence spectral pattern and, thus, its assigned object.

20. The computer-readable medium according to claim 19, further storing instructions to calculate the object specific luminescence spectral pattern of the at least one object to be recognized based on the spectral distribution of the at least one omitted spectral band and the radiance data of the scene and to match the calculated object specific luminescence spectral pattern with the luminescence spectral patterns stored in the data storage unit, and to identify a best matching luminescence spectral pattern and, thus, its assigned object.
